(19) United States
(12) Patent Application Publication
(10) Pub. No.: US 2009/0122341 A1
(43) Pub. Date: May 14, 2009

(54) INFORMATION PROCESSING APPARATUS, INFORMATION PROCESSING METHOD, AND PROGRAM

(75) Inventor: Hideo Natori, Hino-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/282,869

(22) PCT Filed: Jun. 6, 2007
(86) PCT No.: PCT/JP2007/061847

§ 371 Date: Sep. 12, 2008

(30) Foreign Application Priority Data
Jun. 9, 2006 (JP) 2006-161030

(51) Int. Cl. G06F 3/12

(52) U.S. Cl. 358/1.15

(57) ABSTRACT

If there is a setting of a specific function such as a stamp or the like, print setting information including information to realize the specific function is returned to a system so as to be stored into a spool file. The print setting information in the spool file is obtained. Whether or not the information to realize the specific function is included is discriminated. If it is determined that the information to realize the specific function is not included, a command to print an image corresponding to the page is formed. If it is determined that the information to realize the specific function is included, a command to print an image in which the specific function has been performed to the page is formed.

### TECHNICAL FIELD

The invention relates to an information processing apparatus, an information processing method, and a program, in which print data of a spool file in which the print data of pages of a document formed by an application is stored through a system is converted into a command which can be interpreted by a printer and supplied to the printer.

### BACKGROUND ART

As an example of executing printing including print data for transmitting information and print data for displaying a function, for instance, there is a case where when a document which is handled as a confidential document is distributed, such a mark that characters of “CONFIDENTIAL” appear is stamped onto each page of the document, or the like. However, since large costs are required for the work for manually stamping the mark onto each page of printed matter after the printing, a method of printing an electronic digital mark such as “CONFIDENTIAL” together with the document is generally used. The mark such as “CONFIDENTIAL” is called a stamp.

In the case of printing the document with the stamp, an application needs to have an input portion adapted to receive a character string or the like of the stamp which the user desires. Upon printing the document, when the print data of each page of the document is formed, the application needs to synthesize the user-designated stamp and transmit to the printer. That is, it is necessary to edit the document itself each time the stamp which is overlaid to the document is changed. To improve such a drawback, there is a realizing method of the stamp function by a printer driver.

One of the important points in the realizing method of the stamp function by the printer driver is that the setting of the user-designated stamp is correctly reflected to a print result. Timing when the user can change and set the print setting is the timing before a printing process is started. Timing when the printer driver executes a synthesizing process of the stamp in the printing process is the timing after the printing process was started and the document of the application was spooled and a despooling process of the print data of the spooled document was started. Therefore, for example, even if a font, an image such as logo, or the like of the stamp setting has existed upon print setting, there is a possibility that the image does not exist at a point of time when the printer driver executes the synthesizing process.

At the point of time when the despooling process is started, the printer driver is enabled to use resources such as font, image, or the like which is used in the stamp. By constructing as mentioned above, since the setting of the user-designated stamp can be correctly reflected to the print result, a stamp function by the printer driver in consideration of such a point has been proposed.

The following technique has been disclosed in Japanese Patent Application Laid-Open No. 2002-333959 (US Laid-Open No. 2002-0175958). In place of an application, a printer driver inserts print data of a page in which only a stamp has been drawn into an interval of print data of pages of a document which is formed by the application. At a point of time when the stored print images are converted into a print command which can be interpreted by a printer, the printer driver overlays each page of the application and the inserted page on which the stamp has been drawn.

The following technique has been disclosed in Japanese Patent Application Laid-Open No. 2003-015850 (US Laid-Open No. 2003-0002063). At a stage when print data of each page of a document formed by an application is formed, a printer driver converts the print data of the application into print data of a unique format and, at the same time, a font or the like used in a stamp is stored. At a point of time when the stored print data of the unique format is converted into a print command which can be interpreted by a printer, the printer driver draws the stamp in each page of the application.

The related arts as mentioned above have the following problems to be solved.

According to the first method in the related arts, it is necessary that the page which has been formed by the printer driver and in which the stamp or the like has been drawn is inserted into the interval of the pages of the print data of the document formed by the application. Therefore, depending on a print supporting function of an operating system (hereinafter, abbreviated to OS), there is such a drawback that the inserting process of the stamp-drawn page by the printer driver cannot be executed.

According to the second method in the related arts, the font or the like which is used in the stamp is converted into the print data of the unique format and stored together with the print data of each page of the application. Therefore, when internal specifications of the print supporting function of the OS are changed, it is necessary to update the unique format according to such a change. There is, consequently, such a drawback of an increase in costs in order to maintain the function of the printer driver for a long period of time.

### DISCLOSURE OF THE INVENTION

The invention intends to eliminate the drawbacks in the conventional methods.

According to the invention, there is provided a print system in which by using a spool format of print data as a system default which is provided by a print supporting function of an OS, print data including a stamp such as “confidential” is printed without executing an inserting process of a page in which the stamp or the like has been drawn. There is also provided a print system in which a setting of a user-designated stamp can be correctly reflected to a print result.

To accomplish the above object, according to the invention, there is provided an information processing apparatus in which print data of a spool file in which the print data of pages of a document formed by an application is stored through a system is converted into a command which can be interpreted by a printer and supplied to the printer, comprising:

a return unit adapted to, if there is a setting of a specific function, return print setting information including information to realize the specific function to the system so as to store the print setting information into the spool file; and

a forming unit adapted to obtain the print setting information in the spool file, discriminate whether or not the information to realize the specific function is included, form a command to print an image corresponding to the page if it is determined that the information to realize the specific function is not included, and form a command to print an image in which the specific function has been performed to the page if it is determined that the information to realize the specific function is included.

Further features of the present invention will become apparent from the following description of exemplary embodiments with reference to the attached drawings.

### BRIEF DESCRIPTION OF DRAWINGS

FIG. 1 is a block diagram of a print system according to an embodiment of the invention.

FIG. 2 is a block diagram of a printer driver according to the embodiment of the invention.

FIGS. 3A and 3B are diagrams illustrating examples of a print setting dialogue.

FIG. 4 is a diagram illustrating an example of a print setting dialogue.

FIGS. 5A and 5B are conceptual diagrams of a storing method a function displaying document according to the embodiment of the invention.

FIGS. 6A and 6B are conceptual diagrams illustrating relations between a spool file and print results according to the embodiment of the invention.

FIG. 7 is a flowchart showing a storing procedure for the function displaying document which is executed by a user interface driver according to the embodiment of the invention.

FIG. 8 is a flowchart showing a forming procedure of the function displaying document according to the embodiment of the invention.

FIG. 9 is a flowchart showing a procedure for a page synthesizing process according to the embodiment of the invention.

FIG. 10 is a flowchart showing a procedure for the page synthesizing process according to the embodiment of the invention.

FIG. 11 is a timing chart showing the storage of the function displaying document which is executed by the user interface driver according to the embodiment of the invention.

### BEST MODE FOR CARRYING OUT THE INVENTION

The invention will be described in detail hereinbelow based on embodiments illustrated in the drawings. In the following description, USB is an abbreviation of a Universal Serial Bus and is a well-known interface which can make bidirectional communication. Therefore, its detailed description is omitted.

### <Construction of Print System>

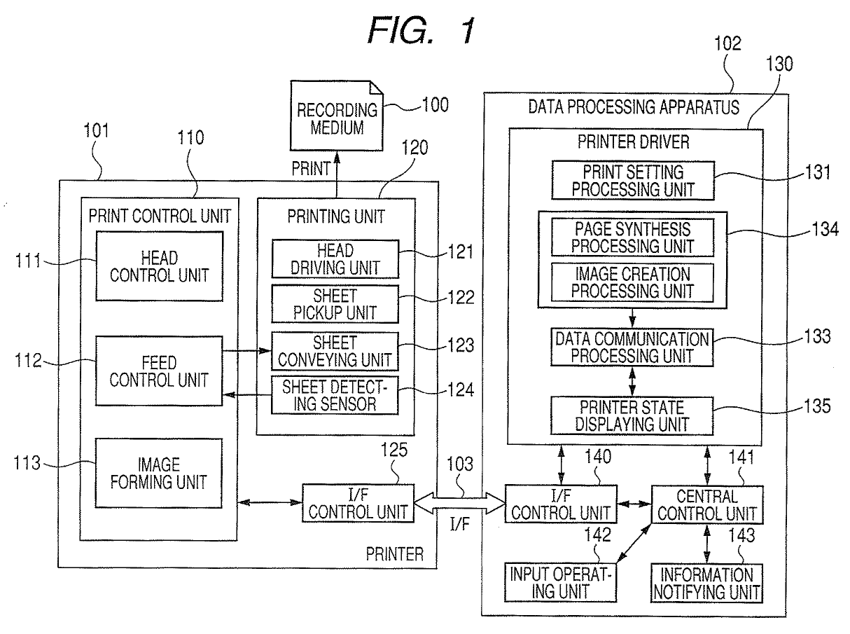

FIG. 1 is a block diagram illustrating a construction of a print system according to the embodiment of the invention.

A printer 101 is a printing apparatus of an ink-jet system for forming an image. The printer 101 forms an image based on a print command formed by a data processing apparatus 102 (information processing apparatus), which will be described hereinafter.

Although not particularly specified with respect to a kind of printing apparatus, a color printer of the ink-jet system is presumed here. The printer 101 is constructed by various functional blocks 110 to 113 and 120 to 125.

In the data processing apparatus 102, application software forms a print job and a printer driver forms image data from a print data of the print job and forms a print command for controlling the printing operation of the connected printer 101.

In the embodiment, a personal computer is used as a data processing apparatus 102. The data processing apparatus 102 also plays a role of receiving an instruction or an input from the user regarding a print setting.

The data processing apparatus 102 is constructed by various functional blocks 130 to 135 and 140 to 143.

The OS for controlling the data processing apparatus 102 has been implemented in the data processing apparatus 102 and the various functional blocks operate on the OS.

A communication interface (I/F) 103 is a communication interface which connects the data processing apparatus 102 and the printer 101.

Although the USB as a serial interface is used in the embodiment, as another interface, a serial interface such as IEEE1394, Ethernet (registered trademark), IrDA, IEEE802.11, electric power line, or the like or a parallel interface such as Centronics, SCSI, or the like can be also used.

Any interface can be used irrespective of a wired/wireless manner so long as it realizes communication.

As mentioned above, the print system of the embodiment is not a single apparatus but has a construction in which the data processing apparatus 102 and the printer 101 for forming the image are connected by a specific bidirectional interface.

However, the invention is not limited to such an example but can be also applied to an apparatus integrated type print system in which functions of the data processing apparatus and the printer as mentioned above are integrated.

In both of the printer 101 and the data processing apparatus 102, the functions which are supposed to be particularly unnecessary when describing features of the embodiment are omitted.

A print control unit 110 receives the print command transmitted from the data processing apparatus 102 and controls the printing operation of a printing unit 120.

The printing unit 120 is a portion for conveying a recording medium 100 and printing onto the recording medium 100.

The recording medium 100 is generally called a print sheet. It is assumed that the recording media 100 have been stacked on a sheet feeding tray, a sheet cassette, or the like provided for the printer 101.

A head control unit 111 controls the operation of a head driving unit 121 and allows ink to be discharged from an orifice of a head.

A feed control unit 112 controls a sheet conveying unit 123 for feeding the recording media 100 one by one from the sheet feeding tray or the sheet cassette provided for the printer 101, conveying the sheet to a printable position through a fixed position on a conveying path, printing a raster image, and executing the sheet discharging operation.

An image forming unit 113 develops image data included in the print command issued from the data processing apparatus 102.

A work area for the controlling operation which is executed by the print control unit 110 and a memory for developing the image data and storing the received print command have been prepared in the print control unit 110. The memory is used by the image forming unit 113.

As mentioned above, the print control unit 110 integratedly controls a printer engine according to commands for print control included in the print command.

Specifically speaking, the print control unit 110 can be realized by a method whereby a CPU executes a program describing a controlling procedure.

As commands for print control, the following commands are used: various kinds of commands for controlling quantized image data for printing, an injection amount of the ink, the number of paths, an orientation of printing, and a conveyance amount of the sheet; and a command constructed by a sheet type instruction which is set by an input operating unit 142, which will be described hereinafter.

The quantized image data includes binary data or intermediate data before the binarization.

The head driving unit 121 executes the printing to the recording medium 100 based on the image data of the print command developed in the print control unit 110.

Since the printer 101 is a printer of the ink-jet system, it forms an image by discharging the ink.

A sheet pickup unit 122 executes the operation for setting the recording media 100 stacked in the sheet feeding tray or the sheet cassette onto the conveying path.

The sheet conveying unit 123 executes the conveying operation for conveying the recording medium 100 set onto the conveying path by the sheet pickup unit along the conveying path and discharging the recording medium through a fixed position.

A sheet detecting sensor 124 is attached on the way of the conveying path, detects an edge portion of the conveyed recording medium 100, and can confirm that the recording medium 100 exists at the fixed position on the conveying path.

An I/F control unit 125 is an I/F control unit for executing an interface function of the printer 101.

In the I/F control unit 125, transmission of sheet information, reception of the print command, and the like are executed. If there is a request also regarding status information showing an error which occurred in the printer main body, a communicating state, or the like, the I/F control unit 125 returns the status information in response to the request to the data processing apparatus 102.

A central control unit 141 controls various functions of the data processing apparatus 102. The function which the CPU has corresponds to the central control unit 141.

The input operating unit 142 is constructed by various input apparatuses for reflecting an intention of the user to the print setting.

A setting information notifying unit 143 notifies the user of the print setting. As a notifying method, a case of using a display apparatus such as a monitor, a notification by a voice sound, or the like is considered.

An I/F control unit 140 executes an interface function of the data processing apparatus 102.

The I/F control unit 140 is constructed by a controller on the host side of the USB and has a function as a USB host.

A part of the function as a USB host is also constructed by software such as OS, driver, or the like.

A printer driver 130 is software for making various settings for printing, forming the print command, and controlling the printer on the data processing apparatus 102. The printer driver 130 has been stored in a hard disk.

Programs of the printer driver are executed by the central control unit 141, so that the functions of a print setting processing unit 131, a print command forming unit 134 including a page synthesis processing unit and an image creation processing unit, a data communication processing unit 133, and the like are realized.

The print setting processing unit 131 makes various print settings including setting of a sheet, setting of print quality, and the like.

The print setting processing unit 131 has a function of receiving instructions or an input from the user and displaying or notifying the set contents.

In the print command forming unit 134, a modifying process for adding a stamp, a background, or the like to the print data of the print job formed by the application is executed in the page synthesis processing unit.

After that, the image data of the print data obtained after the modifying process is formed in the image creation processing unit, thereby forming the print command.

The print command of the print job formed by the print command forming unit 134 is sent to the I/F control unit 140 through the data communication processing unit 133 and transmitted to the printer 101.

A printer state displaying unit 135 displays the status information showing the error, communicating state, or the like of the printer main body which is obtained through the data communication processing unit 133 into a format which can be understood by the user. The printer state displaying unit 135 also promotes the user to take a proper countermeasure for the printer main body based on the status information.

### <Operation of the Printer Driver>

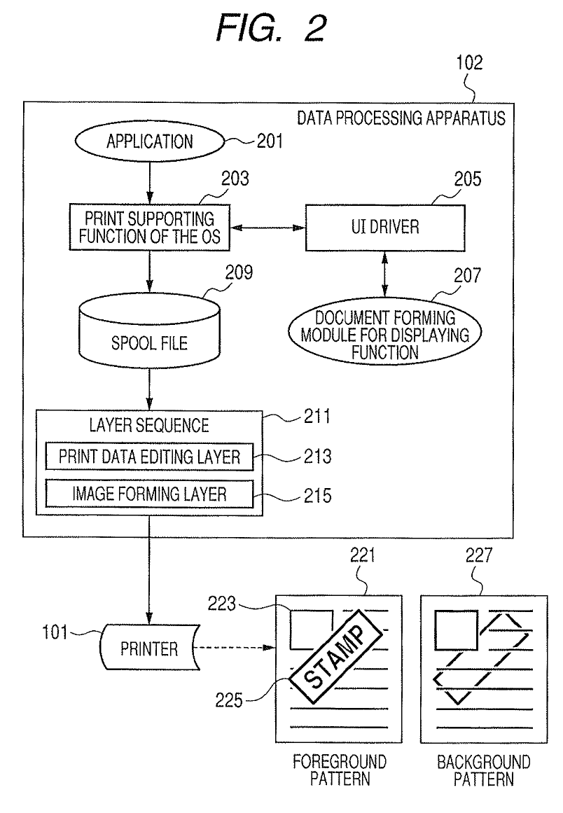

FIG. 2 is a block diagram illustrating the print system of FIG. 1 mainly with respect to a print supporting function of the OS and the printer driver in order to describe the embodiment of the printer driver in the invention.

In FIG. 2, modules regarding the invention include a user interface driver 205, a document forming module 207 for displaying the function, and a layer sequence 211.

Specifically speaking, the user interface driver 205 is a program having a function for setting a pattern for displaying the function and has been stored in the hard disk of the data processing apparatus 102.

The function displaying document forming module 207 is a program for forming a document of an OS standard format including a page in which the function displaying pattern set by the user interface driver 205 has been drawn. The module 207 has been stored in the hard disk of the data processing apparatus 102.

The layer sequence 211 is a program for forming a print command which can be interpreted by the printer from the print data stored by a print supporting function 203 of the OS. The layer sequence 211 has been stored in the hard disk of the data processing apparatus 102.

The layer sequence 211 is constructed by one or more layers.

In FIG. 2, the layer sequence 211 is constructed by a print data editing layer 213 and an image forming layer 215. The print data editing layer 213 has a function for synthesizing the function displaying print data such as a stamp or the like to the print data of the application. The image forming layer 215 has a function for forming the image data from the print data and forming the print command which can be interpreted by the printer.

In the print system in FIG. 2, the print data of each page of the document formed by an application 201 is temporarily stored into a spool file 209 through the print supporting function 203 of the OS. The printer driver develops the print data into the image data (that is, bitmap data), converts into the print command which can be interpreted by the printer, supplies to the printer 101, and prints.

The user interface driver 205 provides a function for setting a size of sheet which is used generally for printing, a printing orientation, and other attributes.

At the same time, as a specific function, the user interface driver 205 of the invention has a pattern setting processing unit for function information which provides an ability adapted to set attributes of the pattern such as a stamp or the like besides the attributes such as sheet size and the like.

When the attributes of the function displaying pattern are set, the user interface driver 205 returns the print setting information in which setting values of a font name, a point number, a color of a frame line, a rotational angle, a position, and the like have been stored to the application 201 if a character string is used.

If an image is used, the user interface driver 205 returns the print setting information in which setting values of a file name, a magnification ratio, a concentration, a position, a layout method, and the like have been stored to the application 201.

The application 201 prints a formed arbitrary document. The application 201 notifies the print supporting function 203 of the OS of the print start or the print end, notifies the function 203 of the print setting information returned from the user interface driver 205 in order to make the print setting, or notifies the function 203 of the drawing start or the drawing end of each page of the document. Each time the print start, a change in print setting, or the like is performed by the application 201, the print supporting function 203 of the OS notifies the user interface driver 205 of print events.

When the user interface driver 205 receives the print event showing that the printing has been started and the print event showing that the print setting has been changed, the user interface driver 205 refers to the print setting information which is supplied together with the print events.

If the setting for drawing the function displaying pattern such as a stamp or the like has been made in the print setting information, the user interface driver 205 calls the function displaying document forming module 207.

The function displaying document forming module 207 forms the document for displaying the function including resources such as font, image, and the like necessary to draw the stamp or the like and the print data of the pages in which the stamp or the like has been drawn and returns to the user interface driver 205.

The user interface driver 205 stores the document for displaying the function returned from the function displaying document forming module into the print setting information and returns the print setting information as return values of the print event indicating that the print setting has been changed.

Subsequently, the print supporting function 203 of the OS stores the print setting information into the spool file 209.

That is, in place of the print setting information notified by the application 201, the print setting information returned by the user interface driver 205 is stored into the spool file 209.

Therefore, the function displaying document formed by the function displaying document forming module 207 is also spooled.

The layer sequence 211 is constructed by one or more layers and has a function for reading the print setting information and the print data from the spool file, converting into the print command which can be interpreted by the printer, supplying to the printer 101, and printing in the printing mode.

The layer sequence 211 in the embodiment has the print data editing layer 213 as a page synthesis processing unit.

First, the print data editing layer 213 reads out the print data of the document page to be printed and the print setting information from the spool file 209.

Subsequently, if the setting for drawing the stamp or the like has been made in the read-out print setting information, the function displaying document is extracted from the print setting information. The print data editing layer 213 synthesizes the resources such as font, image, and the like necessary to draw the function displaying pattern stored in the function displaying document to the print data of the document.

Subsequently, the print data editing layer 213 synthesizes the print data of the page in which the function displaying pattern stored in the function displaying document has been drawn to the print data of the document page and supplies the print data obtained after the synthesization to the image forming layer 215.

The layer sequence 211 in the embodiment also has the image forming layer 215 as an image creation processing unit.

First, the image forming layer 215 develops into the image data based on the print data of the synthesized page supplied from the print data editing layer 213.

Subsequently, the image forming layer 215 converts the developed image data into the print command which can be interpreted by the printer 101 and supplies the converted print command to the printer 101 through the data communication processing unit (not shown in FIG. 2).

The printer 101 as an output device has a function for interpreting the print command sent from a data apparatus as an upper apparatus and forming a visible image onto the print sheet.

An example of the print result illustrated on a print sheet 221 shows a case where the print data editing layer 213 has overlaid the function displaying pattern onto the document page and such a pattern is called a foreground pattern.

An example of the print result illustrated on a print sheet 227 shows a case where the print data editing layer 213 has overlaid the function displaying pattern under the document page and such a pattern is called a background pattern.

Although not illustrated, attributes of the foreground pattern and the background pattern are individually set and the function displaying document forming module 207 stores the page in which the foreground pattern has been drawn and the page in which the background pattern has been drawn into the same function displaying document.

The print data editing layer 213 can also use the foreground pattern and the background pattern by overlaying the background pattern and the print data of each of the document page of the application 201 and the page for displaying the foreground function.

Further, the user interface driver 205 also forms a plurality of foreground function displaying pages and a plurality of background function displaying pages instead of forming one foreground function displaying page and one background function displaying page and the print data editing layer 213 can also overlay the print data of those plurality of function displaying pages and the print data of the document page.

In the case of setting a character string into the attributes of the function displaying pattern in the embodiment, the user interface driver 205 calls the function displaying document forming module 207 at the time of the print start and the change in print setting during the printing.

The function displaying document forming module 207 forms the function displaying document including the function displaying pages in which the character string has been drawn. The user interface driver 205 stores the function displaying document into the print setting information and returns to the print supporting function of the OS.

The print data editing layer 213 forms the print data of the synthetic page in which the print data of the function displaying page and the print data of the document page of the application 201 have been overlaid and supplies to the image forming layer 215.

The image forming layer 215 develops the supplied print data of the synthetic page into the image data in the state where the document page to be printed and the function displaying page have been overlaid, converts the image data into the print command, and supplies the print command to the printer 101.

The correspondence to FIG. 2 will now be described on the assumption that Windows (registered trademark) “Vista” or the like made by Microsoft Corporation is used as an OS. The layer sequence 211 is realized as a filter pipeline and the print data editing layer 213 and the image forming layer 215 are realized as filters in the filter pipeline.

Formats of the function displaying document and the spool file 209 are the XPS (XML Paper Specification) document format.

Although the user interface driver 205 may form the function displaying document, if a construction in which the function displaying document forming module 207 is prepared and the user interface driver 205 calls the function displaying document forming module 207 is used, a maintenance of the functions of the printer driver can be easily performed.

### <Print Setting Display Screen>

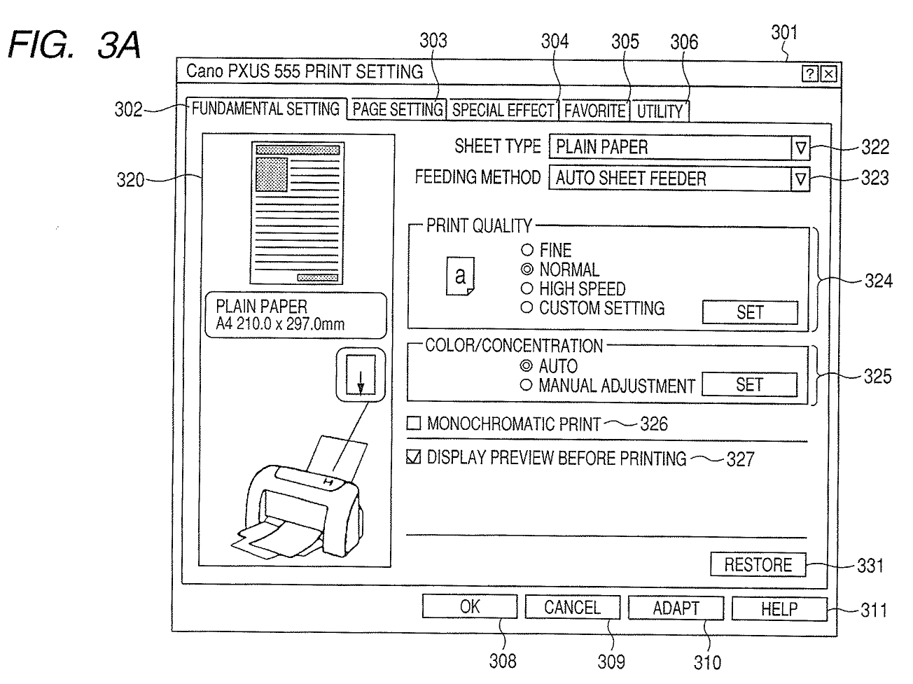

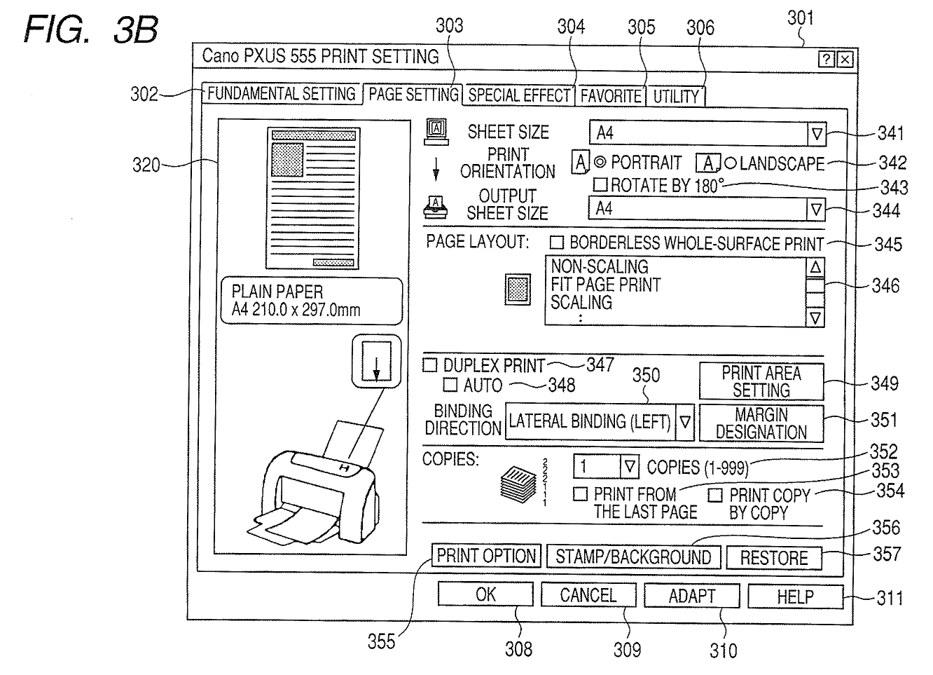

FIGS. 3A, 3B, and 4 are diagrams showing example of a print setting dialogue which is displayed when a printing mode and various sheet settings are made in the embodiment.

In FIG. 3A, a print setting dialogue 301 is constructed by display areas 302 to 311 and 320 to 331. In the print setting, since the number of items to be displayed is very large, generally, the setting items are classified every contents by using tab sheets so that they can be easily seen. Tabs are used also in the embodiment. Similarly, in FIG. 3B, the print setting dialogue 301 is constructed by display areas 302 to 311 and 320 to 357. In a fundamental setting tab 302, the contents regarding the foundation of the printing are displayed.

A page setting tab 303 displays the contents regarding the various page settings such as sheet size, print orientation, print layout (N-up), and the like.

Details of those tabs will be described hereinafter.

A special effect tab 304 displays a display screen for selecting a function which is used in the case of performing various image adjustments and giving a special effect such as sepia tone or the like to the image.

A favorite tab 305 displays a display screen for allowing the user to select a function for storing and calling the print settings or the like which are frequently used. A utility tab 306 displays a display screen for selecting a function for adjustment, cleaning, or the like of the head.

FIG. 4 illustrates a dialogue for setting the stamp/background. A stamp/background setting dialogue 401 is constructed by display areas 402 to 423. The stamp/background setting dialogue 401 is used to select the function displaying pattern which is added upon printing in one of a stamp function of overlaying characters onto the print document and a background function of overlaying an image under the print document.

Those dialogues display the contents regarding the setting and, at the same time, receive a changing instruction of the setting contents or an input from the user.

A display example in the case where the fundamental setting tab 302 has been selected is illustrated in FIG. 3A. Not only character information but also information which has been set in a format adapted to make an appeal to the eyes is displayed in a simple display area 320 for the fundamental setting. A sheet type selecting unit 322 displays the sheet type, thereby enabling the user to select the sheet type.

The sheet type selecting unit 322 is a drop-down menu. Generally, the selected sheet type is displayed in this menu and by clicking it, the sheet types which can be selected are displayed as a list.

The sheet types which can be selected are the types of the sheets which can be printed by the printer and in addition to plain paper shown in the diagram, for example, glossy paper, coating paper, photographic paper, postcard, New Year card, and the like are included.

A sheet feeding method selecting unit 323 displays sheet feeding methods by which the printer main body feeds the sheet, thereby enabling the user to select the sheet feeding method.

By the sheet feeding method selecting unit 323, the user can select, for example, one of the sheet feeding tray or sheet cassette serving as an automatic sheet feeding port, “manual sheet feed” for manually feeding the print sheets one by one, and the like.

A print quality selecting unit 324 is an item for allowing the user to set print quality.

A color adjusting unit 325 is an item for allowing the user to adjust a print color.

A monochromatic print setting unit 326 is a check box for displaying the print result in a gray scale even if the print document is a color document.

A preview print setting unit 327 is a check box for confirming, before the actual printing is executed by the printer, how the various print settings are reflected to the print document.

When a default setting unit 331 is clicked, the setting of the fundamental setting 302 is returned to default (setting upon shipping).

By clicking an OK button 308 after each item was selected, the user can close the print setting dialogue 301 and reflect the selected print setting to the printing.

By clicking a cancel button 309, the print setting dialogue 301 is closed, the contents of the selected setting item are abandoned and are not reflect to the printing.

By clicking an adapt button 310, the selected print setting can be reflect to the printing while keeping the print setting dialogue 301 in the open state.

By clicking a help button 311, a description sentence regarding each setting item can be displayed by different windows.

FIG. 3B illustrates a display example in the case where the page setting tab 303 has been selected.

A sheet size selecting unit 341 displays sheet sizes of the originals which are formed by the application, thereby enabling the user to select the sheet size.

An output sheet size selecting unit 344 displays sizes of sheets which are used to print by the printer, thereby enabling the user to select the sheet size.

In the sheet size 341 and the output sheet size 344, besides A4 shown in the diagram, sheet sizes such as A5, B5, Letter, postcard, and the like which can be used in the printer are included. In the sheet size 341, the sizes such as B4, A3, A2, and the like which cannot be handled in the printer can be also prepared.

In a print orientation selecting unit 342, the orientation of the original which is formed by the application can be selected.

In a 180 degrees rotation selecting unit 343, when the original which is formed by the application is printed, whether or not the print sheet is rotated by 180 degrees and printed to the print sheet can be selected.

In a borderless whole-surface print selecting unit 345 as a print type, a mode to execute a marginless printing to the print sheet can be instructed.

In a print type selecting unit 346, a non-scaling printing, a fit page printing for matching the original of the application with the output sheet size, a scaling printing in which an arbitrary magnification can be set, a print layout (N-up), and the like can be set.

In a duplex print selecting unit 347, whether or not a duplex printing is executed can be selected. In an automatic selecting unit 348, whether an automatic duplex printing is executed or a manual duplex printing is executed upon duplex printing can be selected.

A print area setting button 349 is validated when both of the duplex print selecting unit 347 and the automatic selecting unit 348 are selected. By clicking the print area setting button 349, another dialogue (not shown) is displayed and a print area in the automatic duplex printing can be set.

In a binding direction selecting unit 350, a side to be bound after the printing can be designated. By clicking a binding margin designating button 351, another dialogue (not shown) is displayed and a binding margin width can be set.

A print number setting unit 352 is an item for allowing the user to set the number of print copies. By setting a numerical value of the number of print copies, the print data of the print job formed by the application is repetitively printed the number of times designated by the printer driver, so that the print result of a plurality of copies can be obtained.

A reverse order designating unit 353 is an item for setting whether or not the printing is executed from the last page. A copy-by-copy setting unit 354 is an item for setting whether or not the printing is executed copy by copy. When the setting of the number of print copies 352 is equal to 2 or more, the setting is validated.

By clicking a print option setting unit 355, another dialogue (not shown) is displayed and an option or the like to reduce a size of spool file can be set.

By clicking a stamp/background setting unit 356, a stamp/background setting dialogue illustrated in FIG. 4 is displayed and the setting of the function displaying pattern to be overlaid to the print document can be made.

FIG. 4 illustrates the display example of the stamp/background setting dialogue. In the embodiment, the stamp and the background can be individually set by the stamp/background setting dialogue 401.

In a stamp setting unit 410, by marking a check box, a stamp function can be validated.

In a stamp type setting unit 411, the stamp which has previously been registered can be selected by a drop-down list.

By clicking a stamp setting unit 412, another dialogue (not shown) is opened, the setting of the registered stamp can be changed, and a stamp can be also newly formed and registered.

In a foreground stamp setting unit 413, whether a pattern of the stamp is printed in a foreground of the print data of the application or the pattern of the stamp is printed in a background of the print data of the application can be set.

In a head stamp setting unit 414, whether the pattern of the stamp is synthesized only to the first page of the document of the application or the pattern of the stamp is synthesized to all pages can be set.

In a background setting unit 420, a background function can be validated by marking a check box.

In a background type setting unit 421, a background which has previously been registered can be selected by a drop-down list.

By clicking a background setting unit 422, another dialogue (not shown) is opened, the setting of the registered background can be changed or a background can be newly formed and registered.

In a head background setting unit 423, whether the background pattern is synthesized only to the first page of the document of the application or the background pattern is synthesized to all pages can be set.

When both functions of the stamp and the background are valid and the foreground stamp function is OFF, the print data of the page of the application is printed to the most foreground. Subsequently, the stamp pattern is printed. Finally, the background pattern is printed.

By clicking an OK button 402 after each item was selected, the user can close the stamp/background setting dialogue 401 and reflect the selected print setting to the printing.

By clicking a cancel button 403, the stamp/background setting dialogue 401 is closed and the contents of the selected setting item are abandoned and are not reflected to the printing.

By clicking a restore button 404, the setting value of each setting item on the stamp/background setting dialogue 401 is returned to the default state.

However, the stamp and the background setting values which have been registered in this instance are not influenced.

By clicking a help button 405, a description sentence regarding each setting item on the stamp/background setting dialogue 401 can be displayed by another window.

### <Spool File and Function Displaying Document>

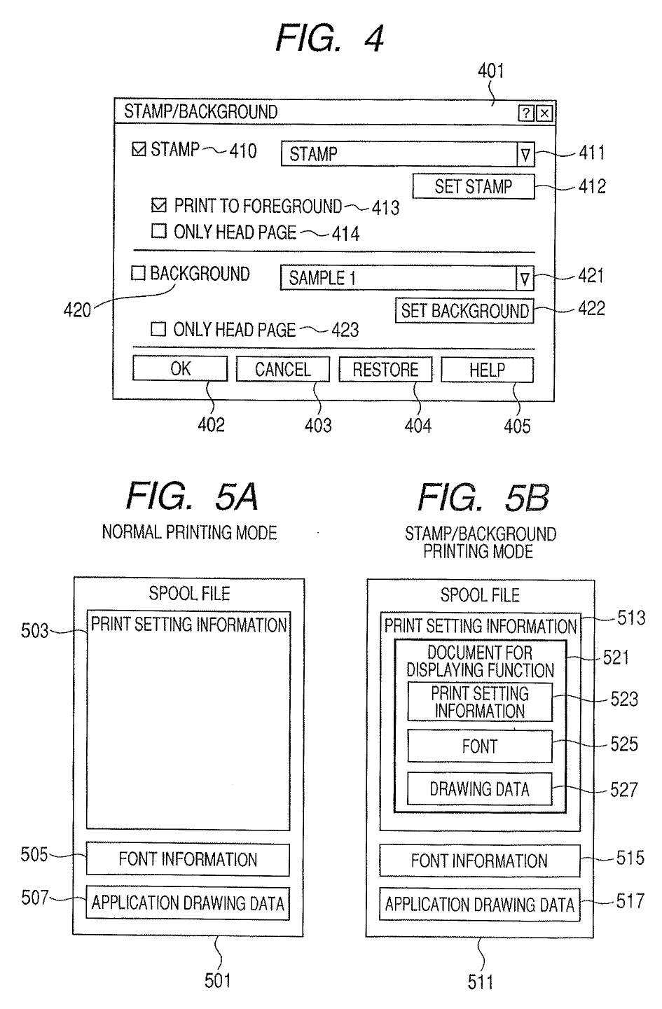

FIGS. 5A and 5B are conceptual diagrams illustrating a structure of the spool file and a structure of the function displaying document which is stored in the print setting information.

The case where a character string has been set as a stamp/background will now be considered.

The structure of the spool file in the normal printing mode in which the stamp/background is not set is shown by a normal printing mode spool file 501.

The normal printing mode spool file 501 is constructed by: print setting information 503; print data 507 of the page drawn by the application; and resources 505 of font information including an outline font file and a bitmap font file which are used in the print data 507.

When the application draws the image, besides the font information, resources (resource information) such as an image including a bitmap file and the like are also stored.

Information such as sheet type, print quality, sheet size, and the like which are set on the display screens of FIGS. 3A, 3B, and 4 is included in the print setting information 503.

Information such as character codes corresponding to characters to be printed, drawing positions of the characters to be printed, font designated for the characters to be printed, and the like are included in print data 507.

The construction of the spool file in the case where the character string has been designated by the stamp/background printing is shown by a stamp/background printing mode spool file 511.

In a manner similar to the normal printing mode spool file 501, the stamp/background printing mode spool file 511 is constructed by: print setting information 513; print data 517 of the page drawn by the application; and resources 515 of the font information used for the drawing by the application.

When the application draws the image, besides the font information including the bitmap font, resources such as an image including the bitmap file and the like are also stored.

The spool file 511 differs from the normal printing mode spool file 501 with respect to a point that a function displaying document 521 stored by the user interface driver exists in the print setting information 513.

The function displaying document 521 is constructed by: drawing data 527 as a function displaying page; resources 525 such as a font and the like which are used for the drawing data 527; and print setting information 523 used when the function displaying page has been drawn.

For example, character codes, size information, and style information of the characters which are used for the stamp are included in the drawing data 527.

The outline font file and the bitmap font file of the characters which are used for the stamp are included in the resources 525.

The font file may be either the file including only the font data of the characters which are used for the stamp or the file including the font data of all characters of a style including the characters which are used for the stamp.

As mentioned above by constructing the function displaying document 521 in a manner similar to the normal printing mode spool file 501, the method which is used when the spool file is analyzed can be used as it is when the function displaying document 521 is analyzed.

When the bitmap is used as a stamp/background, the resources of a function displaying bitmap are stored in the function displaying document 521.

Naturally, the function display of the stamp/background or the like may be replaced by a combination of the font and the bitmap.

The correspondence to FIGS. 5A and 5B will now be described on the assumption that Windows (registered trademark) “Vista” or the like made by Microsoft Corporation is used as an OS. Formats of the function displaying document and the spool file are an XPS document format.

The print setting information is an XML document called “PrintTicket”.

When the user interface driver stores of the function displaying document into the print setting information, binary data of the function displaying document is converted into text data and stored as private elements according to a private schema.

### <Synthesization of Print Data>

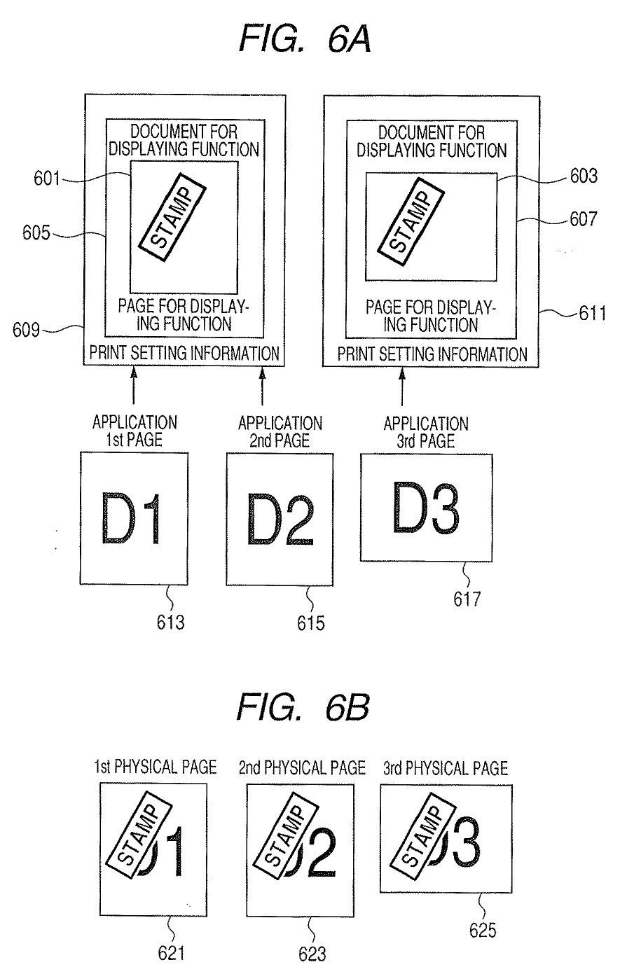

FIGS. 6A and 6B are schematic diagrams illustrating synthesization results of the print data of the application and the print data of the function displaying document.

FIG. 6A illustrates the state where the print job in which the stamp of the character string was set has been spooled.

The document which is printed by the application is constructed by three pages. It is presumed that the first and second pages are printed based on the same print setting and the third page is printed while changing the print orientation to the lateral direction.

The print settings of a first page 613 and a second page 615 of the application are expressed by print setting information 609.

A function displaying document 605 has been stored in the print setting information 609. A function displaying page 601 in which the stamp, background, or the like was drawn has been stored in the function displaying document 605.

Similarly, a print setting of a third page 617 of the application is expressed by print setting information 611.

A function displaying document 607 has been stored in the print setting information 611. A function displaying page 603 in which the pattern was drawn has been stored in the function displaying document 607.

As mentioned above with reference to FIG. 2, each time the application starts the printing or changes the print setting, the user interface driver reforms a function displaying document and stores into the print setting information.

Therefore, in FIG. 6A, the function displaying document 605 has been stored in the print setting information 609 at the time when the application starts the printing, and the function displaying document 607 has been stored in the print setting information 611 at the time when the print setting is changed at the third page, respectively.

Since the application has changed the print orientation among the print settings to the lateral direction at the third page, the print orientation of the function displaying page 603 stored in the function displaying document 607 has been also similarly changed to the lateral direction.

FIG. 6B illustrates the print result in which the page of the application and the function displaying page in FIG. 6A have been synthesized.

A first physical page 621 as a print result shows a result in which the first page 613 of the application and the function displaying page 601 have been synthesized.

Similarly, a second physical page 623 shows a result in which the second page 615 of the application and the function displaying page 601 have been synthesized.

Similarly, a third physical page 625 shows a result in which the third page 617 of the application and the function displaying page 603 have been synthesized.

In the above description, there is illustrated an example in which the print data of the application and the print data of the function displaying document are synthesized with reference to the drawings in which the pattern of the character string is arranged to the foreground of the application.

However, naturally, the pattern can be arranged to the background of the print data of the application or an image instead of the character string can be also used as a pattern.

A synthesizing process in the case where a plurality of foreground and background patterns have simultaneously been set can be also executed by a similar concept.

### <Forming and Storing Processes of Function Displaying Document>

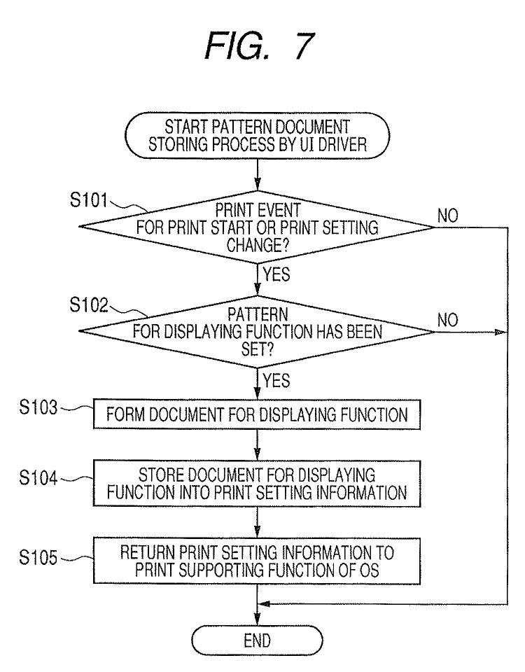

Forming and storing processes of the function displaying document upon spooling of the print data of the application will now be described with reference to FIGS. 7, 8, and 11.

FIG. 7 is a flowchart regarding a program for the storing process of the function displaying document which is executed by the user interface driver.

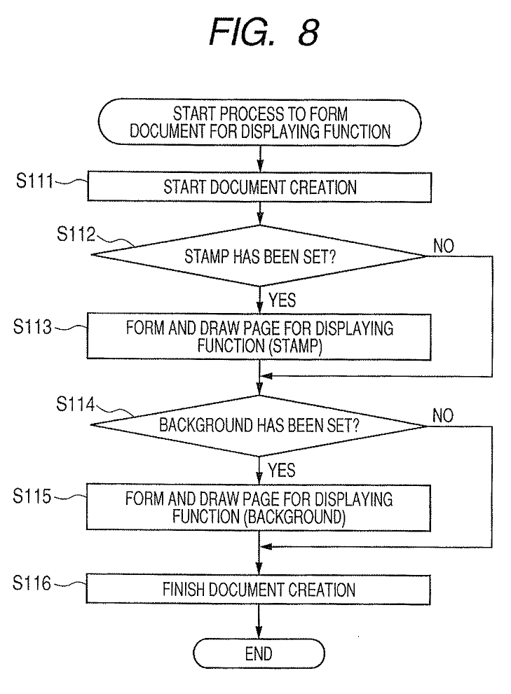

FIG. 8 is a flowchart regarding a program for the forming process of the function displaying document which is executed by a function displaying document forming module.

First, the storing process of the function displaying document by the user interface driver will be described with reference to FIG. 7.

When the application starts the printing or changes the print setting, the user interface driver is notified of the print event by the print supporting function of the OS.

Also when the application starts or finishes the printing of the page in the document, the user interface driver is notified of the print event.

When the user interface driver receives the print event, in S101, the driver discriminates whether it is a print event to start the printing or a print event to change the print setting.

In the case of the print event for the print start or the print setting change, S102 follows. In another print setting, the processing routine is finished.

In S102, whether or not the print setting which needs to draw the function displaying pattern such as stamp or background has been set is discriminated with reference to the print setting information notified together with the print event.

If the print setting which needs to draw the function displaying pattern has been set, S103 follows. If there is no need to draw the function displaying pattern, the processing routine is finished.

In S103, the user interface driver activates the function displaying document forming module so as to form the function displaying document including the function displaying page. At this time, the user interface driver supplies the print setting information to the function displaying document forming module. The forming process of the function displaying document by the function displaying document forming module will be described hereinafter with reference to FIG. 8.

In next S104, the formed function displaying document is stored together with the print event into the notified print setting information.

In subsequent S105, the print setting information in which the function displaying document has been stored is returned to the print supporting function of the OS.

The print supporting function of the OS spools the print setting information in which the function displaying document has been stored.

The function displaying document forming process by the function displaying document forming module will now be described with reference to FIG. 8.

First, starting processes such as initialization necessary to form the function displaying document, storage of the print setting information, and the like is executed in S111.

Subsequently, whether or not the stamp function has been set in the print setting information is discriminated in S112.

If the stamp function has been set, S113 follows. If the stamp function is not set, S114 follows.

In S113, the function displaying page is formed in the function displaying document and the pattern of the stamp is drawn.

In S114, whether or not the background function has been set in the print setting information is discriminated.

If the background function has been set, S115 follows. If the background function is not set, S116 follows.

In S115, the function displaying page is formed in the function displaying document and the pattern of the background is drawn.

Finally, in S116, a finishing process necessary to complete the creation of the function displaying document is executed.

By forming the function displaying document as mentioned above, the font information and image information which are used in the stamp and background are stored into the function displaying document.

After the function displaying page of the stamp was formed, first, the function displaying page of the background has been formed here. However, this order may be reversed.

Although an example of the stamp and background has been shown as a function displaying pattern here, the number of function displaying patterns may be 1 or 3 or more.

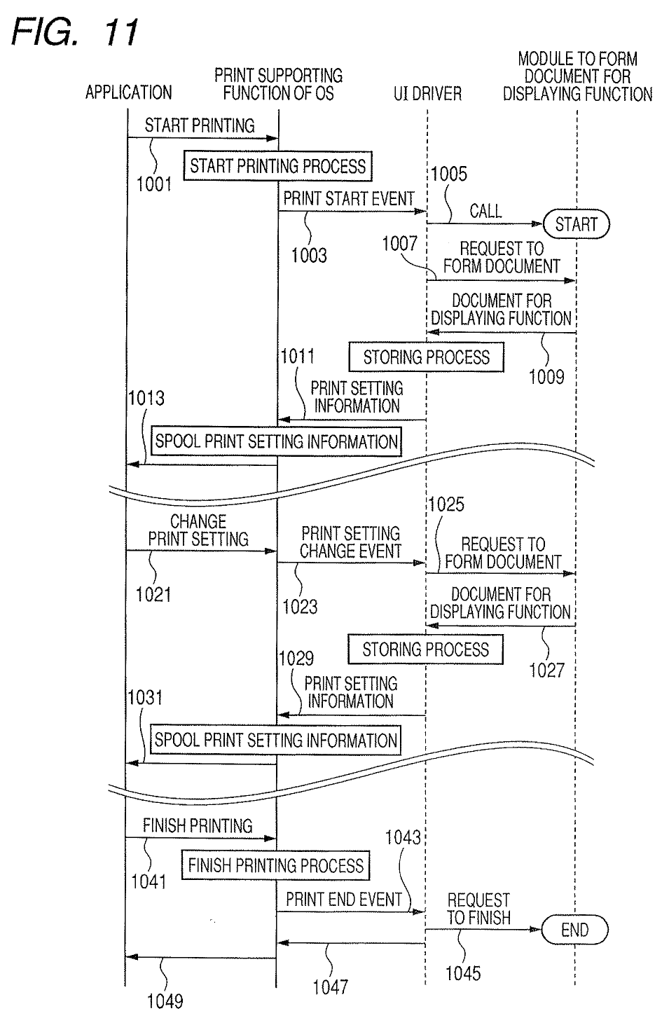

FIG. 11 is a timing chart for the forming and storing processes of the function displaying document at the time of the spooling of the print data of the application.

The drawing of the page of the document of the application is omitted here.

When the application requests the print start in 1001, the print supporting function of the OS executes a print starting process. The user interface driver is notified of the print event to start the printing in 1003.

Together with the notification of the print event for the print start, the print setting information is sent to the user interface driver.

The user interface driver analyzes the print setting information. If it is determined that the function displaying pattern such as stamp/background or the like has been set, the user interface driver calls the function displaying document forming module in 1005.

Subsequently, the user interface driver requests the function displaying document forming module to form the function displaying document in 1007. At this time, the user interface driver supplies the print setting information to the function displaying document forming module.

The function displaying document forming module forms the function displaying document and supplies to the user interface driver in 1009.

The user interface driver stores the function displaying document into the print setting information and returns the print setting information to the print supporting function of the OS in 1011.

The print supporting function of the OS stores the print setting information returned from the user interface driver into the spool file and returns the control to the application in 1013.

If the application changes the print setting in 1021 during the printing, the print supporting function of the OS notifies the user interface driver of the print event for the print setting change in 1023.

Together with the notification of the print event for the print setting change, the print setting information is sent to the user interface driver.

The user interface driver analyzes the print setting information. If it is determined that the function displaying pattern such as stamp/background or the like has been set, the user interface driver requests the function displaying document forming module to form the function displaying document in 1025. At this time, the user interface driver supplies the print setting information to the function displaying document forming module.

If the function displaying document forming module is not called at this point of time, this module is called before requesting the creation of the function displaying document.

The function displaying document forming module forms the function displaying document and supplies to the user interface driver in 1027. The user interface driver stores the function displaying document into the print setting information and returns the print setting information to the print supporting function of the OS in 1029.

The print supporting function of the OS stores the print setting information returned from the user interface driver into the spool file and returns the control to the application in 1031.

When the application requests to finish the printing in 1041, the print supporting function of the OS executes the print finishing process and notifies the user interface driver of the print event for the print start in 1043.

When the function displaying document forming module has already been called, the user interface driver requests the function displaying document forming module to finish the operation in 1045.

When the function displaying document forming module receives the end request, the module finishes the operation.

The control is returned from the user interface driver to the print supporting function of the OS in 1047. The control is returned from the print supporting function of the OS to the application in 1049.

### <Page Synthesizing Process>

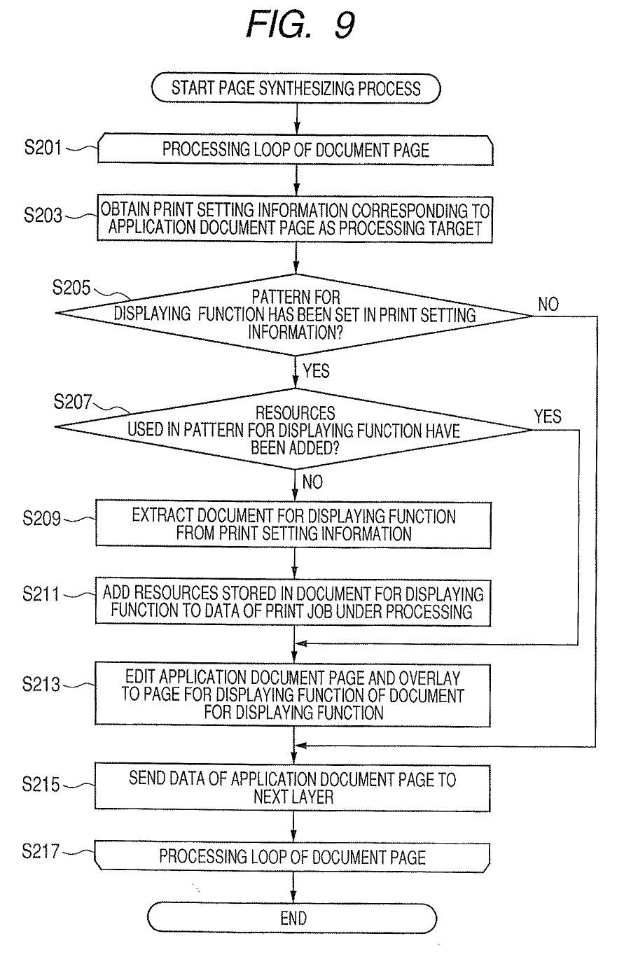

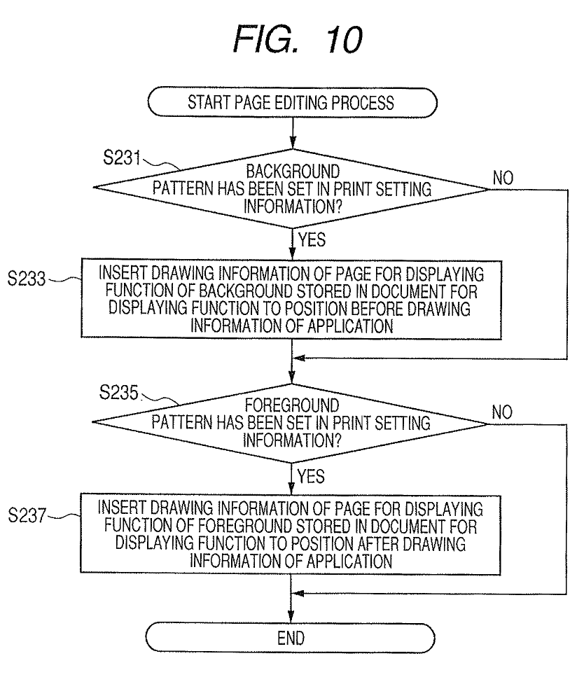

A page synthesizing process which is executed by a print data editing layer of a layer sequence upon despooling will be described with reference to FIGS. 9 and 10.

FIG. 9 is a flowchart for the page synthesizing process regarding a program which is executed by the print data editing layer.

In FIG. 9, S201 to S217 relate to a loop for executing a pattern synthesizing process for the print data of the page of the application which has been spooled.

In this loop, first, in S203, the print setting information corresponding to the page of the application as a processing target is obtained.

As mentioned above, the print setting information has also been stored in the spool file together with the print data of the page of the application.

Subsequently, whether or not the print setting which needs the synthesization with the function displaying pattern such as a stamp/background or the like has been made in the print setting information is discriminated in S205.

If the print setting which needs the synthesization has been made, S207 follows. If the synthesization is unnecessary, S215 follows.

Whether or not the resources such as font, image, or the like which are used in the synthesization of the function displaying pattern have already been added to the print data which is being processed is discriminated in S207.

If the resources which are used in the synthesization are not added yet, S209 follows. If the resources have already been added, S213 follows.

The resources such as font, image, or the like which are used in the stamp synthesization are not necessary for the print data of each page but it is sufficient that they have been added once to the print data of the print job which is being processed.

In the stamp synthesization for a plurality of pages, the same resources can be referred to and this is true of the synthesization of the background.

The function displaying document is extracted from the print setting information in S209.

Subsequently, in S211, the resources such as font, image, or the like stored in the function displaying document are added to the print data of the print job which is being processed.

In S213, the print data of the page of the application during the process is edited and synthesized with the function displaying page.

Details of the synthesizing process will be described hereinafter with reference to FIG. 10.

The print data of the page as a processing target is transmitted to the next layer in S215.

Specifically speaking, if there is a setting of the function displaying pattern, the print data obtained by synthesizing the function displaying page to the print data of the page as a processing target is transmitted to the next layer in S215.

In S215, if there is no setting of the function displaying pattern, the print data of the page as a processing target (print data to which the function displaying page is not synthesized) is transmitted to the next layer.

In the embodiment, it is presumed that the next layer is an image forming layer as mentioned above by using FIG. 2.

If there is the setting of the function displaying pattern, the image forming layer develops the image data of the page to which the function displaying pattern has been synthesized from the print data of the page synthesized by the print data editing layer and, further, converts it into the print command which can be interpreted by the printer.

If there is no setting of the function displaying pattern, the image forming layer develops the image data of the normal page which does not include the function displaying pattern from the print data upon normal printing which has been transmitted by the print data editing layer and, further, converts it into the print command which can be interpreted by the printer.

The layer sequence is not constructed only by the two layers.

It is also possible to combine, for example, an N-up layer having a function of arranging a plurality of pages to one print surface, for example, a poster layer having a function of dividing and arranging one page to a plurality of print surfaces, or the like. On the contrary, the construction can be also simplified by collecting a plurality of functions to a single layer.

Finally, whether or not the page of the application as a processing target is the last page is discriminated in S217. If it is not the last page, the processing routine advances to the next page and is returned to S201. If it is the last page, the processing routine is finished.

FIG. 10 is a flowchart for a page editing process regarding a program which is executed by the print data editing layer and shows details of the process of S213.

The processes for editing the print data of the page of the document of the application and synthesizing the print data of the page of the function displaying document will be described with reference to FIG. 10.

First, whether or not the setting of the background pattern exists in the print setting information is discriminated in S231. If there is the setting of the background pattern, S233 follows. If there is no setting of the background pattern, S235 follows.

In S233, drawing information is extracted from the print data of the function displaying page of the background stored in the function displaying document and inserted to a position before the drawing information of the print data of the page of the application. Whether or not the setting of the foreground pattern exists in the print setting information is discriminated in S235. If there is the setting of the foreground pattern, S237 follows. If there is no setting of the foreground pattern, the processing routine is finished.

In S237, the drawing information is extracted from the print data of the function displaying page of the foreground stored in the function displaying document and inserted to a position after the drawing information of the print data of the page of the application.

By executing the above processes, the drawing information in the print data of the page of the application after the edition is arranged in such order that, first, the function displaying pattern of the background is arranged, the print data of the page of the application is subsequently arranged, and the function displaying pattern of the foreground is finally arranged.

By using such layout order, when the print data after the edition is transmitted to the image forming layer and developed into the image data, first, the background pattern is drawn, the print data of the page of the application is subsequently drawn, and the foreground pattern is finally drawn.

Therefore, the print setting of the stamp/background made by the user interface driver mentioned above by using FIG. 4 is reflected to the print result.

The foreground pattern in the embodiment is the stamp setting in which the foreground stamp setting unit in FIG. 4 is ON.

The background pattern is the stamp setting in which the foreground stamp setting unit in FIG. 4 is OFF and the background setting in FIG. 4.

It is now assumed that the layer sequence in the embodiment is constructed by the two layers of the print data editing layer and the image forming layer. However, naturally, a plurality of functions can be also realized by a single layer in order to simplify the construction.

As described above, according to the embodiment, the following effects are obtained.

(1) When the print data including the stamp is printed, even if the printer driver cannot insert the function displaying page into an interval between the pages of the print data of the application, the setting of the stamp designated by the user can be correctly reflected to the print result.

(2) Since the spool format of the OS standard print data which is provided by the print supporting function of the OS is used, the maintenance of the functions of the printer driver can be easily performed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-161030, filed Jun. 9, 2007, which is hereby incorporated by reference herein in its entirety.

1. An information processing apparatus in which print data of a spool file in which the print data of pages of a document formed by an application is stored through a system is converted into a command which can be interpreted by a printer and supplied to the printer, comprising:
a return unit, adapted to, if there is a setting of a specific function, return print setting information including resource information to realize the specific function to the system so as to store the print setting information into the spool file; and
a forming unit, adapted to obtain the print setting information in the spool file, discriminate whether or not the setting of the specific function is included, form a command to print an image corresponding to the page if it is determined that the setting of the specific function is not included, and form a command to print an image in which the specific function has been performed to the page if it is determined that the setting of the specific function is included.

2. An information processing apparatus according to claim 1, wherein the specific function includes either a stamp function or a background function.

3. An information processing apparatus according to claim 1, wherein if there is the setting of the specific function, the return unit activates a module for forming the resource information to realize the specific function, allows the activated module to form a function displaying document including the resource information to realize the specific function, and returns the print setting information including the formed function displaying document to the system so as to store the print setting information into the spool file.

4. An information processing apparatus according to claim 3, wherein the spool file includes print setting information and print data, and wherein the forming unit extracts the function displaying document from the print setting information in the spool file and combines the extracted function displaying document with the print data to form the command to print an image in which the specific function has been performed.

5. An information processing apparatus according to claim 1, wherein when a print setting is changed, the return unit returns the print setting information including the resource information to realize the specific function according to the print setting to the system so as to store the print setting information into the spool file.

6. An information processing apparatus according to claim 1, wherein the forming unit obtains the print setting information in the spool file, discriminates whether or not the setting of the specific function is included, forms the command to print the image corresponding to the page if it is determined that the setting of the specific function is not included, and forms a command to print the image in which the specific function has been performed to each of the pages by inserting drawing information of the specific function to a position before or after drawing information of each of the pages if it is determined that the setting of the specific function is included.

7. An information processing method whereby print data of a spool file in which the print data of pages of a document formed by an application is stored through a system is converted into a command which can be interpreted by a printer and supplied to the printer, comprising:
a return step of, if there is a setting of a specific function, returning print setting information including resource information to realize the specific function to the system so as to store the print setting information into the spool file; and
a forming step of obtaining the print setting information in the spool file, discriminating whether or not the setting of the specific function is included, forming a command to print an image corresponding to the page if it is determined that the setting of the specific function is not included, and forming a command to print an image in which the specific function has been performed to the page if it is determined that the setting of the specific function is included.

8. An information processing method according to claim 7, wherein the specific function includes either a stamp function or a background function.

9. An information processing method according to claim 7, wherein in the return step, if there is the setting of the specific function, a module for forming the resource information to realize the specific function is activated, the activated module is allowed to form a function displaying document including the resource information to realize the specific function, and the print setting information including the formed function displaying document is returned to the system so as to be stored into the spool file.

10. An information processing method according to claim 9, wherein the spool file includes print setting information and print data, and wherein the forming step extracts the function displaying document from the print setting information in the spool file and combines the extracted function displaying document with the print data to form the command to print an image in which the specific function has been performed.

11. An information processing method according to claim 7, wherein in the return step, when a print setting is changed, the print setting information including the resource information to realize the specific function according to the print setting is returned to the system so as to be stored into the spool file.

12. An information processing method according to claim 7, wherein in the forming step, the print setting information in the spool file is obtained, whether or not the setting of the specific function is included is discriminated, if it is determined that the setting of the specific function is not included, the command to print the image corresponding to the page is formed, and if it is determined that the setting of the specific function is included, a command to print the image in which the specific function has been performed to each of the pages by inserting drawing information of the specific function to a position before or after drawing information of each of the pages is formed.

13. A computer-readable storage medium which stores a computer program for allowing a computer to execute functions for converting print data of a spool file in which the print data of pages of a document formed by an application is stored through a system into a command which can be interpreted by a printer and supplying the command to the printer, the computer program comprising:
a return step of, if there is a setting of a specific function, returning print setting information including resource information to realize the specific function to the system so as to store the print setting information into the spool file; and
a forming step of obtaining the print setting information in the spool file, discriminating whether or not the setting of the specific function is included, forming a command to print an image corresponding to the page if it is determined that the setting of the specific function is not included, and forming a command to print an image in which the specific function has been performed to the page if it is determined that the setting of the specific function is included.

14. A storage medium according to claim 13, wherein the specific function includes either a stamp function or a background function.

15. A storage medium according to claim 13, wherein in the return step, if there is the setting of the specific function, a module for forming the resource information to realize the specific function is activated, the activated module is allowed to form a function displaying document including the resource information to realize the specific function, and the print setting information including the formed function displaying document is returned to the system so as to be stored into the spool file.

16. A storage medium according to claim 15, wherein the spool file includes print setting information and print data, and wherein the forming step extracts the function displaying document from the print setting information in the spool file and combines the extracted function displaying document with the print data to form the command to print an image in which the specific function has been performed.

17. A storage medium according to claim 13, wherein in the return step, when a print setting is changed, the print setting information including the resource information to realize the specific function according to the print setting is returned to the system so as to be stored into the spool file.

18. A storage medium according to claim 13, wherein in the forming step, the print setting information in the spool file is obtained, whether or not the setting of the specific function is included is discriminated, if it is determined that the setting of the specific function is not included, the command to print the image corresponding to the page is formed, and if it is determined that the setting of the specific function is included, a command to print the image in which the specific function has been performed to each of the pages by inserting drawing information of the specific function to a position before or after drawing information of each of the pages is formed.
